(19) United States
(12) Patent Application Publication
(10) Pub. No.: US 2007/0110915 A1
(43) Pub. Date: May 17, 2007

(54) Thermal spray powder and method for forming a thermal spray coating

(76) Inventors: Junya Kitamura, Kakamigahara-shi (JP); Isao Aoki, Tajimi-shi (JP)

Correspondence Address: VIDAS, ARRETT & STEINKRAUS, P.A., 6109 BLUE CIRCLE DRIVE, SUITE 2000, MINNETONKA, MN, 55343-9185, US

(21) Appl. No.: 11/591,870

(22) Filed: Nov. 2, 2006

(30) Foreign Application Priority Data
Nov. 2, 2005 (JP) 2005-320118

(51) Int. Cl. B05D 1/08; C23C 4/00; C04B 35/505

(52) U.S. Cl. 427/446; 501/152

(57) ABSTRACT

A thermal spray powder contains granulated and sintered particles which contain yttria and an yttrium-aluminum double oxide. The aluminum content in the granulated and sintered particles is 50 to 10,000 ppm by mass on an alumina basis. It is preferred that the thermal spray powder be used in applications for forming a thermal spray coating by plasma thermal spraying at atmospheric pressure.

### BACKGROUND OF THE INVENTION

The present invention relates to a thermal spray powder containing granulated and sintered particles which contain yttria and a method for forming a thermal spray coating obtained by using such thermal spray powder.

In the field of manufacturing of semiconductor devices and liquid crystal devices, the microfabrication of the devices is performed by dry etching using plasma. There have been known techniques which involve providing a thermal spray coating in portions of semiconductor device manufacturing equipment and liquid crystal device manufacturing equipment which may be subjected to etching damage by plasma during the plasma process, whereby the plasma etching resistance of these portions is improved (refer to Japanese Laid-Open Patent Publication No. 2002-80954, for example). By improving the plasma etching resistance in this manner, the scattering of particles is suppressed, resulting in an improvement in the yield of devices.

A thermal spray coating used in such applications can be formed by plasma thermal spraying of a thermal spray powder containing, for example, granulated and sintered yttria particles. Although development of thermal spray powders aimed to improve the plasma etching resistance of thermal spray coatings has been carried out, a thermal spray powder capable of meeting required performance has not been obtained as of yet.

### SUMMARY OF THE INVENTION

The object of the present invention is to provide a thermal spray powder suitable for the formation of a thermal spray coating excellent in plasma etching resistance and a method for forming a thermal spray coating.

To achieve the above object, the present invention provides a thermal spray power containing granulated and sintered particles which contain yttria and an yttrium-aluminum double oxide. The aluminum content in the granulated and sintered particles is 50 to 10,000 ppm by mass.

The present invention provides also a method for forming a thermal spray coating. The method includes forming a thermal spray coating by plasma thermal spraying of the above-described thermal spray powder at atmospheric pressure.

### DETAILED DESCRIPTION OF THE PREFERRED EMBODIMENTS

An embodiment of the present invention will be described below.

A thermal spray powder according to the present embodiment consists of granulated and sintered particles comprised of yttria and an yttrium-aluminum double oxide. Although the yttrium-aluminum double oxide in the granulated and sintered particles may be any one selected from the group consisting of yttrium aluminum garnet (abbreviated as YAG), yttrium aluminum perovskite (abbreviated as YAP) and yttrium aluminum monoclinic crystal (abbreviated as YAM), it is preferred that the yttrium-aluminum double oxide be YAG from the standpoint of crystal stability.

The thermal spray powder of this embodiment, i.e., the granulated and sintered particles which is comprised of yttria and an yttrium-aluminum double oxide are prepared by granulating and sintering a raw material powder consisting of yttrium-based raw material particles and aluminum-based raw material particles. More concretely, the thermal spray powder is prepared by first preparing a granulated powder from the raw material powder, then sintering and breaking the granulated powder into smaller particles, and further classifying as required the sintered powder which is broken into smaller particles.

The preparation of the granulated powder from the raw material powder may be performed by spray-granulating a slurry obtained by mixing the raw material powder with an appropriate dispersant and adding a binder as required, or it may be performed by tumbling-granulating or compression-granulating to directly prepare the granulated powder from the raw material powder. Although the sintering of the granulated powder may be performed in any of atmospheric air, a vacuum or an inert gas atmosphere, it is preferable to perform this in atmospheric air in terms of the conversion of yttrium in the raw material powder into yttria. An electric furnace or a gas furnace can be used in the sintering of the granulated powder. The sintering temperature is preferably 1,200 to 1,700° C., more preferably 1,300 to 1,700° C. The time for which a maximum temperature is held during sintering is preferably 30 minutes to 10 hours, more preferably 1 to 5 hours.

The yttrium-based raw material particles contained in the raw material powder comprises of a substance capable of being converted into yttria in the processes of granulation and sintering of the raw material powder, such as metal yttrium and yttrium fluoride, or yttria. However, from the standpoint of a reduction of material cost and an improvement in the crystallinity of the yttria in the granulated and sintered particles, it is preferred that the yttrium-based raw material particles be comprised of yttria.

The aluminum-based raw material particles contained in the raw material powder comprises a substance which reacts with the substance capable of being converted into yttria or the yttria in the yttrium-based raw material particles in the processes of granulation and sintering of the raw material powder and form an yttrium-aluminum double oxide, such as aluminum hydroxide, or alumina, such as transition alumina and corundum. Incidentally, transition alumina is a generic name for alumina other than α-alumina (corundum), such as γ-alumina, θ-alumina and δ-alumina, and among others, γ-alumina is particularly common.

In a thermal spray coating formed by the thermal spraying of granulated and sintered particles containing yttria and an yttrium-aluminum double oxide, the proceeding of the etching of the thermal spray coating by plasma at an interface between the yttria and the yttrium-aluminum double oxide in the thermal spray coating is temporarily delayed and, therefore, there is a possibility that an improvement in the plasma etching resistance may occur. However, in a case where the aluminum content in the granulated and sintered particles is less than 50 ppm by mass on an alumina basis, the density of the interface between the yttria and the yttrium-alumina double oxide in the thermal spray coating decreases and, therefore, an improvement in the plasma etching resistance of the thermal spray coating is scarcely observed. Therefore, in order to obtain a thermal spray coating excellent in plasma etching resistance, it is essential that the aluminum content in the granulated and sintered particles be no less than 50 ppm by mass on an alumina basis. In a case where the aluminum content in the granulated and sintered particles is less than 80 ppm by mass on an alumina basis, in a further case where the aluminum content is less than 100 ppm by mass on an alumina basis, the plasma etching resistance of the thermal spray coating is not improved very much even when the aluminum content is no less than 50 ppm by mass. Therefore, for a further improvement in the plasma etching resistance of the thermal spray coating, the aluminum content in the granulated and sintered particles is preferably no less than 80 ppm by mass on an alumina basis and more preferably no less than 100 ppm by mass on an alumina basis.

In order to obtain a thermal spray coating excellent in plasma etching resistance, it is also essential that the aluminum content in the granulated and sintered particles be no more than 10,000 ppm by mass on an alumina basis. When the aluminum content exceeds 10,000 ppm by mass on an alumina basis, the proportion of an yttrium-aluminum double oxide, which is inferior to yttria in plasma etching resistance, in the thermal spray coating becomes too high and, for this reason, the plasma etching resistance of the thermal spray coating decreases contrarily. In a case where the aluminum content in the granulated and sintered particles exceeds 9,000 ppm by mass on an alumina basis, and in a further case where the aluminum content exceeds 8,000 ppm by mass on an alumina basis, there is a concern that the plasma etching resistance of the thermal spray coating may decrease a little due to a relatively high proportion of an yttrium-aluminum double oxide in the thermal spray coating even when the aluminum content is no more than 10,000 ppm by mass. Therefore, for a further improvement in the plasma etching resistance of the thermal spray coating, the content of alumina particles in the thermal spray powder is preferably no more than 9,000 ppm by mass on an alumina basis and more preferably no more than 8,000 ppm by mass on an alumina basis.

In a case where the average particle diameter of the yttrium-based raw material particles contained in the raw material powder exceeds 10 μm, in a further case where the average particle diameter exceeds 8 μm, and in another case where the average particle diameter exceeds 7 μm, the density of the interface between the yttria and the yttrium-aluminum double oxide in the thermal spray coating does not increase very much and, therefore, the plasma etching resistance of the thermal spray coating is not improved very much. Therefore, for a further improvement in the plasma etching resistance of the thermal spray coating, the average particle diameter of the yttrium-based raw material particles contained in the raw material powder is preferably no more than 10 μm, more preferably no more than 8 μm, and most preferably no more than 7 μm.

In a case where the average particle diameter of the aluminum-based raw material particles contained in the raw material powder exceeds 1 μm, the density of the interface between the yttria and the yttrium-aluminum double oxide in the thermal spray coating does not increase very much and, therefore, the plasma etching resistance of the thermal spray coating is not improved very much. Also, there is a concern that the plasma etching resistance of the thermal spray coating may decrease a little because the grain (particle) size of the yttrium-aluminum double oxide in the thermal spray coating becomes relatively large. As described above, the yttrium-aluminum double oxide is inferior to yttria in plasma etching resistance and, therefore, the plasma etching resistance of the thermal spray coating tends to decrease as the grain size of the yttrium-aluminum double oxide in the thermal spray coating increases. Therefore, for a further improvement in the plasma etching resistance of the thermal spray coating, it is preferred that the average particle diameter of the aluminum-based raw material particles contained in the raw material powder be no more than 1 μm.

In a case where the average particle diameter of the granulated and sintered particles contained in the thermal spray powder is less than 20 μm, in a further case where the average particle diameter is less than 22 μm, in another case where the average particle diameter is less than 25 μm, and in an additional case where the average particle diameter is less than 28 μm, there is a concern that relatively fine particles may be contained in the granulated and sintered particles, resulting in a concern that a thermal spray powder having good flowability may not be obtained. Therefore, for an improvement in the flowability of the thermal spray powder, the average particle diameter of the granulated and sintered particles contained in the thermal spray powder is preferably no less than 20 μm, more preferably no less than 22 μm, still more preferably no less than 25 μm, and most preferably no less than 28 μm. As the flowability of the thermal spray powder decreases, the supply of the thermal spray powder to a thermal spray flame tends to become unstable, with the result that the plasma etching resistance of a thermal spray coating tends to become nonuniform. The etching of a thermal spray coating by plasma proceeds preferentially from portions of the thermal spray coating having low plasma etching resistance and, therefore, a thermal spray coating having nonuniform plasma etching resistance has a tendency to be inferior in plasma etching resistance.

On the other hand, in a case where the average particle diameter of the granulated and sintered particles contained in the thermal spray powder exceeds 60 μm, in a further case where the average particle diameter exceeds 57 μm, in another case where the average particle diameter exceeds 55 μm, and in an additional case where the average particle diameter exceeds 52 μm, there is a concern that the granulated and sintered particles may not be sufficiently softened or melted with ease by a thermal spray flame, resulting in a concern that the deposit efficiency of the thermal spray powder may decrease. Therefore, for an improvement in the deposit efficiency, the average particle diameter of the granulated and sintered particles contained in the thermal spray powder is preferably no more than 60 μm, more preferably no more than 57 μm, still more preferably no more than 55 μm, and most preferably no more than 52 μm.

In a case where the angle of repose of the granulated and sintered particles contained in the thermal spray powder exceeds 45 degrees, in a further case where the angle of repose exceeds 42 degrees, and in another case where the angle of repose exceeds 40 degrees, there is a concern that a thermal spray powder having good flowability may not be obtained. Therefore, for an improvement in the flowability of the thermal spray powder, the angle of repose of the granulated and sintered particles contained in the thermal spray powder is preferably no more than 45 degrees, more preferably no more than 42 degrees, and most preferably no more than 40 degrees. As described above, as the flowability of the thermal spray powder decreases, the supply of the thermal spray powder to a thermal spray flame tends to become unstable, with the result that the plasma etching resistance of a thermal spray coating tends to become nonuniform.

When the bulk specific gravity of the granulated and sintered particles contained in the thermal spray powder is less than 1, it is difficult to obtain a thermal spray coating having high denseness. Therefore, for an improvement in the denseness of the thermal spray coating, it is preferred that the bulk specific gravity be no less than 1. Incidentally, a thermal spray coating having a low denseness has a high porosity. The etching of a thermal spray coating by plasma proceeds preferentially also from areas around pores in the thermal spray coating and, therefore, a thermal spray coating having a high porosity has a tendency to be inferior in plasma etching resistance.

Although the upper limit to the bulk specific gravity of the thermal spray powder is not specially limited, from the standpoint of practicality, it is preferred that the bulk specific gravity of the thermal spray powder be no more than 3.0.

The thermal spray powder of this embodiment is used in applications for forming a thermal spray coating by plasma thermal spraying or other thermal spraying methods. The pressure of the atmosphere in which the thermal spray powder is plasma thermal sprayed is preferably atmospheric pressure. In other words, it is preferred that the thermal spray powder be used in applications for plasma thermal spraying at atmospheric pressure. When the pressure of the atmosphere during plasma thermal spraying is not atmospheric pressure, particularly in the case of an atmosphere under a reduced pressure, there is a concern that the plasma etching resistance of a thermal spray coating which is obtained may decrease a little. When the thermal spray powder is plasma thermal sprayed under a reduced pressure, there is a concern that the reduction of the yttria in the thermal spray powder may occur during the thermal spraying, resulting in a concern that lattice defects caused by the deficiency of oxygen tends to be contained in the thermal spray coating. The etching of a thermal spray coating by plasma proceeds preferentially also from defect portions in the thermal spray coating and, therefore, a thermal spray coating formed by plasma thermal spraying under a reduced pressure has a tendency to be inferior to a thermal spray coating formed by plasma thermal spraying under an atmospheric pressure in plasma etching resistance.

This embodiment has the following advantages.

The thermal spray powder of this embodiment consists of granulated and sintered particles comprised of yttria and an yttrium-aluminum double oxide, and the aluminum content in the granulated and sintered particles is set at 50 to 10,000 ppm by mass on an alumina basis. For this reason, it is possible to effectively increase the density of the interface between the yttria and the yttrium-aluminum double oxide in the thermal spray coating without inducing the decrease in the plasma etching resistance of the thermal spray coating caused by too high a proportion of the yttrium-aluminum double oxide in the thermal spray coating. Therefore, a thermal spray coating formed from the thermal spray powder of this embodiment is excellent in plasma etching resistance. In other words, the thermal spray powder of this embodiment is suitable for the formation of a thermal spray coating excellent in plasma etching resistance.

The above-described embodiment may be modified as follows.

The thermal spray powder may contain components other than granulated and sintered particles comprised of yttria and an yttrium-aluminum double oxide. However, it is preferred that the amounts of the components contained in the thermal spray powder other than granulated and sintered particles be as little as possible.

The granulated and sintered particles contained in the thermal spray powder may contain components other than yttria and an yttrium-aluminum double oxide. However, the total content of yttria and an yttrium-aluminum double oxide in the granulated and sintered particles is preferably no less than 90%, more preferably no less than 95%, and most preferably no less than 99%. Although the components other than yttria and an yttrium-aluminum double oxide in the granulated and sintered particles are not especially limited, it is preferred that these components be rare earth oxides.

The raw material powder of the granulated and sintered particles may contain components other than the yttrium-based raw material particles and the aluminum-based raw material particles. However, it is preferred that the amounts of the components other than the yttrium-based raw material particles and the aluminum-based raw material particles be as little as possible.

Next, the present invention will be more concretely described by citing examples and comparative examples.

Thermal spray powders of Examples 1 to 13 and Comparative Examples 1 to 6, which consist of granulated and sintered particles comprised of yttria and an yttrium-aluminum double oxide (YAG), were prepared by granulating and sintering a raw material powder consisting of yttrium-based raw material particles and aluminum-based raw material particles. And a thermal spray coating was formed by plasma thermal spraying each of the thermal spray powders. Details of the thermal spray powders and thermal spray coatings are as shown in Table 1. The thermal spraying conditions (conditions for plasma thermal spraying at atmospheric pressure and conditions for plasma thermal spraying under a reduced pressure) used in forming the thermal spray coatings are shown in Table 2.

The column entitled “Aluminum content in granulated and sintered particles” in Table 1 shows the aluminum content in the granulated and sintered particles contained in each of the thermal spray powders (on an alumina basis).

The column entitled “Average particle diameter of granulated and sintered particles” in Table 1 shows the average particle diameter of the granulated and sintered particles contained in each of the thermal spray powders, which was measured by use of a laser diffraction/scattering particle size measuring apparatus “LA-300” made by Horiba, Ltd.

The column entitled “Angle of repose of granulated and sintered particles” in Table 1 shows the angle of repose of the granulated and sintered particles contained in each of the thermal spray powders, which was measured by use of an ABD-powder characteristic measuring instrument “ABD-72 model” made by Tsutsui Rikagaku Co., Ltd.

The column entitled “Material for yttrium-based raw material particles” in Table 1 shows the material for the yttrium-based raw material particles contained in the raw material powder of each of the thermal spray powders.

The column entitled “Material for aluminum-based raw material particles” in Table 1 shows the material for the aluminum-based raw material particles contained in the raw material powder of each of the thermal spray powders.

The column entitled “Average particle diameter of aluminum-based raw material particles” in Table 1 shows the average particle diameter of the aluminum-based raw material particles contained in the raw material of each of the thermal spray powders, which was measured by use of a laser diffraction/scattering particle size measuring apparatus “LA-300” made by Horiba, Ltd.

The column entitled “Thermal spraying atmosphere” in Table 1 shows the pressure of an atmosphere used in the plasma thermal spraying of each of the thermal spray powders to form a thermal spray coating.

The column entitled “Deposit efficiency” in Table 1 shows results for an evaluation of the deposit efficiency, which is the ratio of the weight of a thermal spray coating formed by the thermal spraying of each of the thermal spray powders to the weight of the thermal spray powder used in thermal spraying. In the column, the numeral 1 (Excellent) denotes that the deposit efficiency was no less than 50%, the numeral 2 (Good) denotes that the deposit efficiency was no less than 45% but less than 50%, and the numeral 3 (NG) denotes that the deposit efficiency was less than 45%.

The column entitled “Denseness” in Table 1 shows results for an evaluation of the denseness of a thermal spray coating formed by the thermal spraying of each of the thermal spray powders. Concretely, first, each of the thermal spray coatings was cut at a plane orthogonal to a top surface of the thermal spray coating, and the cut surface was mirror polished by use of colloidal silica having an average particle diameter of 0.06 μm. After that, the porosity on the cut surface of the thermal spray coating was measured by use of an image analysis processing device “NSFJ1-A” of N-Support Corp. In the column entitled “Denseness”, the numeral 1 (Excellent) denotes that the porosity was less than 6%, the numeral 2 (Good) denotes that the porosity was no less than 6% but less than 12%, and the numeral 3 (NG) denotes that the porosity was no less than 12%.

The column entitled “Plasma etching resistance” in Table 1 shows results for an evaluation of the plasma etching resistance of thermal spray coatings formed by the thermal spraying of each of the thermal spray powders. Concretely, first, the surface of each of the thermal spray coatings was mirror polished by use of colloidal silica having an average particle diameter of 0.06 μm. Part of the surface of the thermal spray coating after the polishing was masked with polyimide tape and the whole surface of the thermal spray coating was then plasma etched under the conditions shown in Table 3. After that, the height of a step between a masked portion and a nonmasked portion was measured by use of a step measuring device “Alpha-Step” of KLA-Tencor Corporation. In the column entitled “Plasma etching resistance”, the numeral 1 (Excellent) denotes that the etching rate calculated by dividing the height of a step by etching time was less than 40 nm/minute, the numeral 2 (Good) denotes that the etching rate was no less than 40 nm/minute but less than 50 nm/minute, and the numeral 3 (NG) denotes that the etching rate was no less than 50 nm/minute.

TABLE 1

| | Aluminum content | Average particle | Angle of repose | Material for | Average particle |
|---|---|---|---|---|---|
| | in granulated and | diameter | of granulated and | yttrium-based | diameter of yttrium- |
| | sintered particles | of granulated and sintered | sintered particles | raw material | based raw material |
| | [ppm by mass] | particles [μm] | [degrees] | particles | particles [μm] |
| Comparative | 40 | 45 | 42 | Yttria | 0.6 |
| Example 1 | | | | | |
| Comparative | 40 | 45 | 43 | Yttria | 0.6 |
| Example 2 | | | | | |
| Comparative | 40 | 45 | 44 | Yttria | 0.6 |
| Example 3 | | | | | |
| Example 1 | 100 | 45 | 40 | Yttria | 0.6 |
| Example 2 | 1000 | 45 | 38 | Yttria | 0.6 |
| Example 3 | 5000 | 45 | 34 | Yttria | 0.6 |
| Example 4 | 5000 | 45 | 36 | Yttria | 0.6 |
| Example 5 | 5000 | 45 | 39 | Yttria | 0.6 |
| Example 6 | 5000 | 45 | 39 | Yttria | 0.6 |
| Example 7 | 8000 | 45 | 32 | Yttria | 0.6 |
| Comparative | 12000 | 45 | 32 | Yttria | 0.6 |
| Example 4 | | | | | |
| Comparative | 12000 | 45 | 31 | Yttria | 0.6 |
| Example 5 | | | | | |
| Comparative | 12000 | 45 | 32 | Yttria | 0.6 |
| Example 6 | | | | | |
| Example 8 | 5000 | 22 | 40 | Yttria | 0.6 |
| Example 9 | 5000 | 17 | 45 | Yttria | 0.6 |
| Example 10 | 5000 | 52 | 39 | Yttria | 0.6 |
| Example 11 | 5000 | 62 | 39 | Yttria | 0.6 |
| Example 12 | 5000 | 45 | 41 | Yttria | 6.5 |
| Example 13 | 5000 | 45 | 34 | Yttria | 0.6 |

| | Material for | Average particle | | | | |
|---|---|---|---|---|---|---|
| | aluminum-based | diameter of | | | | |
| | raw material | aluminum-based raw | Thermal spraying | Deposit | | Plasma |
| | particles | material particles [μm] | atmosphere | efficiency | Denseness | etching resistance |
| Comparative | γ-alumina | 0.02 | Atmospheric air | 1 | 1 | 3 |
| Example 1 | | | | | | |
| Comparative | Corundum | 0.30 | Atmospheric air | 1 | 1 | 3 |
| Example 2 | | | | | | |
| Comparative | Aluminum | 0.10 | Atmospheric air | 1 | 1 | 3 |
| Example 3 | hydroxide | | | | | |
| Example 1 | γ-alumina | 0.02 | Atmospheric air | 1 | 1 | 2 |
| Example 2 | γ-alumina | 0.02 | Atmospheric air | 1 | 1 | 1 |
| Example 3 | γ-alumina | 0.02 | Atmospheric air | 1 | 1 | 1 |
| Example 4 | Corundum | 0.30 | Atmospheric air | 1 | 1 | 1 |
| Example 5 | Corundum | 1.20 | Atmospheric air | 1 | 1 | 2 |
| Example 6 | Aluminum | 0.10 | Atmospheric air | 1 | 1 | 1 |
| | hydroxide | | | | | |
| Example 7 | γ-alumina | 0.02 | Atmospheric air | 1 | 1 | 2 |
| Comparative | γ-alumina | 0.02 | Atmospheric air | 1 | 1 | 3 |
| Example 4 | | | | | | |
| Comparative | Corundum | 0.30 | Atmospheric air | 1 | 1 | 3 |
| Example 5 | | | | | | |
| Comparative | Aluminum | 0.10 | Atmospheric air | 1 | 1 | 3 |
| Example 6 | hydroxide | | | | | |
| Example 8 | γ-alumina | 0.02 | Atmospheric air | 1 | 1 | 1 |
| Example 9 | γ-alumina | 0.02 | Atmospheric air | 1 | 1 | 2 |
| Example 10 | γ-alumina | 0.02 | Atmospheric air | 2 | 2 | 1 |
| Example 11 | γ-alumina | 0.02 | Atmospheric air | 2 | 2 | 2 |
| Example 12 | γ-alumina | 0.02 | Atmospheric air | 2 | 1 | 2 |
| Example 13 | γ-alumina | 0.02 | Reduced pressure | 1 | 1 | 2 |

TABLE 2

Conditions for plasma thermal spraying at atmospheric pressure
Base material: Al alloy sheet (A6061)(50 mm × 75 mm × 5 mm)
subjected to blasting treatment by
use of brown alumina abrasives (A#40)
Thermal spray machine: “SG-100” made by Praxair
Powder supply machine: “Model 1264” made by Praxair
Ar gas pressure: 50 psi (0.34 MPa)
He gas pressure: 50 psi (0.34 MPa)
Voltage: 37.0 V
Current: 900 A
Thermal spraying distance: 120 mm
Thermal spray powder feed rate: 20 g/minute
Conditions for plasma thermal spraying under a reduced pressure
Base material: Al alloy sheet (A6061)(50 mm × 75 mm × 5 mm)
subjected to blasting treatment by
use of brown alumina abrasives (A#40)
Thermal spray machine: “F4” made by Sulzer-Metco
Powder supply machine: “Twin 10” made by Sulzer-Metco
Ar gas flow rate: 42 l/minute
He gas pressure: 10 l/minute
Voltage: 43.0 V
Current: 620 A
Thermal spraying distance: 200 mm
Thermal spray powder feed rate: 20 g/minute

TABLE 3
Etching device: Reactive ion etching device “NLD-800” of ULVAC, Inc.
Etching gas: CF₄
Etching gas flow rate: 0.054 l/minute
Chamber pressure: 1 Pa
Plasma output: 800 W
Etching time: 1 hour

As shown in Table 1, in the thermal spray coatings of Examples 1 to 13, results are obtained that are satisfactory with respect to plasma etching resistance in terms of practical use. In contrast to this, in the thermal spray coatings of Comparative Examples 1 to 6, results are not obtained that are satisfactory with respect to plasma etching resistance in terms of practical use.

1. A thermal spray powder comprising granulated and sintered particles which contain yttria and an yttrium-aluminum double oxide, wherein the aluminum content in the granulated and sintered particles is 50 to 10,000 ppm by mass on an alumina basis.

2. The thermal spray powder according to claim 1, wherein the granulated and sintered particles are obtained by granulating and sintering a raw material powder which contains yttrium-based raw material particles and aluminum-based raw material particles, the yttrium-based raw material particles contain a substance capable of being converted into yttria in processes including granulation and sintering of the raw material powder or yttria, and the aluminum-based raw material particles contain a substance which reacts with the substance capable of being converted into yttria or the yttria in the yttrium-based raw material particles in said processes and form an yttrium-aluminum double oxide.

3. The thermal spray powder according to claim 2, wherein the average particle diameter of the aluminum-based raw material particles contained in the raw material powder is no more than 1 μm.

4. The thermal spray powder according to claim 1, wherein the average particle diameter of the granulated and sintered particles is 20 to 60 μm.

5. The thermal spray powder according to claim 1, wherein the angle of repose of the thermal spray powder is no more than 45 degrees.

6. The thermal spray powder according to claim 1, wherein the thermal spray powder is used in an application for forming a thermal spray coating by plasma thermal spraying at atmospheric pressure.

7. A method for forming a thermal spray coating, comprising forming a thermal spray coating by plasma thermal spraying of a thermal spray powder at atmospheric pressure, wherein the thermal spray powder contains granulated and sintered particles which contain yttria and an yttrium-aluminum double oxide, the aluminum content in the granulated and sintered particles being 50 to 10,000 ppm by mass on an alumina basis.
